(19) United States
(12) Patent Application Publication
(10) Pub. No.: US 2019/0077106 A1
(43) Pub. Date: Mar. 14, 2019

(54) Apparatus, Method and System for the Careful Pre-Folding of Carton Sleeves

(71) Applicant: SIG Technology AG, Neuhausen am Rheinfall (CH)

(72) Inventor: Michael Heil, Moenchengladbach (DE)

(21) Appl. No.: 15/739,393

(22) PCT Filed: May 18, 2016
(86) PCT No.: PCT/EP2016/061081

§ 371 Date: Dec. 22, 2017

(30) Foreign Application Priority Data
Jun. 25, 2015 (DE) 10 2015 110 235.8

(51) Int. Cl. B31B 50/00; B31B 50/52

(52) U.S. Cl. CPC B31B 50/002; B31B 2100/002; B31B 50/52

(57) ABSTRACT

An apparatus for the pre-folding of carton sleeves includes at least two folding bars for pre-folding the ridge areas and the triangular areas of the carton sleeves, and at least one folding block that can be introduced into the carton sleeves. The folding bars each have at least one contact area for pre-folding the ridge areas. In addition a method and a system are provided for the pre-folding of carton sleeves. In order to achieve a particularly careful and damage-free pre-folding of the carton sleeves, it is proposed to provide at least one back folder for folding back the triangular areas.

The invention relates to an apparatus for the pre-folding of carton or packaging sleeves, comprising: at least two folding jibs or folding bars for the pre-folding of the ridge areas and triangular areas of the carton sleeve, and at least one folding block or former that can be introduced into the carton sleeve, wherein the folding bars have in each case at least one contact area for the pre-folding of the ridge areas.

The invention also relates to a method for the pre-folding of carton sleeves as well as a system for the pre-folding of carton sleeves.

Packaging can be produced in various ways and from a wide variety of materials. A widely employed possibility of production consists in producing from the packaging material a blank usually comprising fold lines (also termed “crease” lines), from which by folding and further steps first of all a carton sleeve is formed and finally a packaging. This variant has inter alia the advantage that the blanks are very flat and can therefore be stacked in a space-saving manner. In this way the blanks and carton sleeves can be produced at site other than where the folding and filling of the carton sleeves takes place. Composites are often used as material, for example a composite of several thin plies of paper, cardboard, plastic or metal. Such packaging means are widely used in particular in the foodstuffs industry.

Before the carton sleeves can be finally folded and sealed, a so-called pre-folding often takes place. For this, in order to reduce the folding forces required in the subsequent final folding the individual layers of the composite materials are broken along the provided crease lines, which is why this is also called a “pre-breaking”. A pre-folding of the carton sleeves moreover has further advantages. First of all the pre-folding—unlike the final folding—can take place before the sterilization and/or filling of the carton sleeves, so that during the pre-folding folding tools can also be used that are introduced into the interior of the carton sleeves. In the pre-folding it is therefore possible to allow the folding tools to act on both sides, i.e. from the inside as well as from the outside, of the carton sleeves. For hygienic reasons this is hardly possible after the sterilization and/or the filling of the carton sleeves. By the use of folding tools acting on both sides the carton sleeves can be pre-folded extremely precisely, and in particular very accurate folding edges can be produced. In addition, due to the pre-folding a specific folding direction can already be predetermined, so that particularly simple tools can be used for the final folding. These simple tools can for example be fixed rails that flip over the pre-folded regions of the carton sleeve that are guided past on the rails.

From WO 02/00522 A1 a method is known for reducing the stresses in the region of the crease lines of carton sleeves. It is proposed to heat the material of the carton sleeve in the region of the crease lines before the folding. The heating should be effected for example by hot air and should make the material layers of the carton sleeve more elastic and thus less susceptible to crack formation. A disadvantage of this method however is the fact that it requires a very high energy input in order to heat the air and thereby heat the carton sleeves. A further disadvantage lies in the fact that too great a heating action can lead to discolorations or damage to the carton sleeves.

From U.S. Pat. No. 6,357,203 an apparatus is known for the pre-folding of the ridge areas of a packaging. The apparatus described there is part of an overall installation and the pre-folding of the ridge areas should take place after the folding and closure of the floor areas and before filling the packaging. The apparatus comprises two arms mounted in a rotatable manner and a mandrel that can be lowered into the packaging. Triangular flap elements are provided on the ends of the arms, whose shape corresponds to the triangular areas in the region of the ridge of the packaging. Two folding heads with in each case a folding edge are mounted in a rotatable manner on the mandrel. The triangular flap elements are intended to fold the triangular areas inwardly, whereby the fold lines are “broken” along the fold edges of the folding heads.

A disadvantage of the apparatus known from U.S. Pat. No. 6,357,203 is that no back folders are provided. This means that the mandrel, which during the pre-folding is arranged within the carton sleeve, can be removed only with difficulty and during its withdrawal impacts against the inwardly folded ridge regions. This can lead to damage to the inside of the carton sleeve, which can give rise to the already previously described hygiene problems.

In addition to the apparatus known from U.S. Pat. No. 6,357,203 many other known types of apparatus and methods are also aimed at achieving in the pre-folding folded edges that are as precise as possible. For this purpose folding tools are often used that firmly clamp the carton sleeve in the immediate vicinity of the crease lines so that the carton sleeve is fixed in position during the folding procedure. Although this has the advantage that the formation of creases is prevented, it has the disadvantage however that cracks can occur in some plies of the carton sleeve. The cracks occur in particular at points at which several crease lines cross. This phenomenon therefore occurs particularly in the ridge region, and is also termed “crease cross break”. An undesired consequence of this damage is that the packaged foodstuffs could come into contact with plies of the carton sleeve that are not germ-free, for example with an inner-lying cardboard layer. The packaged foodstuffs could be contaminated in this way and would therefore no longer be fit for human consumption.

Against this background the object of the invention is to develop and modify the apparatus mentioned in the introduction and described hereinbefore as well as the method mentioned in the introduction and described hereinbefore and the system mentioned in the introduction and described hereinbefore, in such a way that a particularly careful and damage-free pre-folding of the carton sleeve can be accomplished without an increased use of energy.

In addition the object of the invention is to provide a carton sleeve from which a folding block or former can be removed without damaging the inner-lying areas of the carton sleeve. Furthermore the carton sleeve should form an opening that is ideal for the following filling process as well as the subsequent sealing process.

This object is achieved with an apparatus according to the preamble of Claim 1 by at least one back folder for folding back the triangular areas.

The apparatus is characterized first of all by at least two folding bars for the pre-folding of the ridge areas and triangular areas of the carton sleeve. The ridge areas and the triangular areas are those areas that are arranged in the ridge region of the carton sleeve. The pre-folding can take place “actively” (i.e. by contact between the folding tool and the area to be folded) or “passively” (i.e. without contact between the folding tool and the area to be folded). For example, the folding bars can force the ridge areas actively inwards, whereby the triangular areas are forced passively outwards. Furthermore, at least one folding block or former is provided in the apparatus, which can be introduced into the carton sleeve. This means that the folding block has to be shaped and supported so that it can be introduced into one of the two openings of the carton sleeve, i.e. into the ridge opening or into the floor opening. The folding bars of the apparatus should in each case have at least one contact area for the pre-folding of the ridge areas. The term contact area is understood to mean that area which during the folding process comes into contact if only temporarily with the ridge areas to be folded.

The apparatus comprises according to the invention at least one back folder for folding back the triangular areas. The back folder can be connected for example to one of the folding bars and in particular can be fixed to one of the folding bars. If several back folders are provided, the back folders can be connected to the same or to different folding bars or fastened thereto. The back folder performs the task of folding the pre-folded areas back a bit further. This has the advantage for example that the folding block can be removed particularly easily from the carton sleeve. In particular damage to the insides of the carton sleeve, which could be caused for example by the often quite sharp folding edges of the folding block, can be avoided. Preferably the back folders do not produce a permanent folding back, but only a temporary retention of the pre-folded areas of the carton sleeve. This has the advantage that the pre-folded areas are held back while the folding block is removed from the carton sleeve, and following this return to the pre-folded position.

According to an elaboration of the apparatus the folding block is mounted in a linearly displaceable manner. A linearly displaceable mounting has several advantages: it can be implemented in a structurally simple and cost-effective manner and allows a precise insertion of the folding block into the carton sleeve, whose edges normally also run linearly. Preferably the folding block is mounted linearly displaceable in the vertical direction, i.e. at right angles to the typically horizontally running transportation path of the carton sleeve.

A further development of the apparatus envisages that the folding block has a web portion with a web width of less than 3 mm, in particular less than 2 mm. In the folding devices known from the prior art the web areas of the carton sleeve are during the pre-folding often pressed from both sides against the web of the folding block. Although this allows precise folding lines between the ridge areas and the web areas, it has the disadvantage of a high loading of the carton sleeve. This is because in particular the web areas are clamped between the folding tool and the web, resulting in an increased risk of the formation of cracks. This danger can be counteracted by a particularly small web width in the aforementioned region. The advantage of such narrow web widths is that the web areas are not pressed against the web during the pre-folding. Instead the gap between the folding tool and the web is wider than the material thickness of the carton sleeve.

According to a further elaboration of the apparatus it is envisaged that the folding block has two oppositely arranged folding edges for folding the ridge areas. The folding edges have the task of forming particularly precise folding lines. The material of the carton sleeve is during the pre-folding folded “over” the folding edges of the folding block, whereby the shape of the folding lines is predetermined and defined. Although a precondition for this is an accurate positioning of the folding block, it however allows the formation of significantly more precise folding lines than would be possible in a pre-folding that uses simply the crease lines as “folding aid”.

As regards this elaboration of the invention it is furthermore proposed that the length of the folding edges is at least 5% less than the length of the ridge areas to be folded. The length of the folded lines can also be at least 10% less than the length of the ridge areas to be folded. Since the folding edges are adjusted shorter than the areas to be folded onto them, a particularly careful folding becomes possible. This is because the folding edges do not extend into the corners of the carton sleeve, and instead small free spaces remain there. Although the free spaces mean on the one hand that the precision of the folding lines in this region is somewhat less, on the other than they allow a movement of the material of the carton sleeve. The danger of crack formation in movable regions of the carton sleeve is significantly less than in clamped regions, since the material of the carton sleeve there can move back into the free spaces and avoid being subjected to too high loads.

According to a further development of the apparatus it is envisaged that the folding block has two oppositely arranged supporting surfaces, which are arranged between the folding edges and the web and have an angle of inclination of 5° or less with respect to a horizontal plane. The formation of a very small angle of inclination in the aforementioned region means that the ridge areas during the pre-folding do not rest against the supporting surfaces and are not clamped there. Instead a free space remains between the supporting surfaces and the carton sleeve. This too enables a particularly careful folding to be achieved. As has already been described hereinbefore, this is due in particular to the fact that the material of the carton sleeve can be displaced and can move back into the free space. This reduces the danger of crack formation. The angle of inclination can in particular be 0°.

According to a further elaboration of the apparatus the folding bars are arranged and rotatably mounted on opposite sides of the folding block. Due to their arrangement on opposite sides of the folding block the folding bars can from different sides reach the carton sleeve arranged underneath the folding block and in particular can fold two opposite sides of the carton sleeve simultaneously. A rotatable mounting of the folding bars forms a structurally simple solution that allows the folding bars to move between an open position—which allows a transportation of the carton sleeves—and a closed position—in which the pre-folding of the carton sleeve takes place.

In a further modification of the apparatus it is envisaged that the contact areas of the folding bars are formed planar. In particular it may be envisaged that the contact areas of the folding bars are formed planar also in the region of the triangular areas, and thus over the whole width of the flat folded carton sleeve. An overall planar formation of the contact areas has of course the disadvantage that the carton sleeve cannot be supported in the region of the ear-shaped sections during the pre-folding and therefore less precise folding lines are formed there. The advantage lies again however in a more careful pre-folding. In fact, owing to the planar formation free spaces remain between the ear-shaped portions of the carton sleeve and the contact areas of the folding bars during the pre-folding. The material of the carton sleeve can therefore move back into the free space in the region of the ear-shaped portions during the pre-folding, which reduces the danger of crack formation.

A further elaboration of the apparatus envisages that the back folders can have a conical and/or spherical head. The head can for example be spherically shaped at its tip, which adjoins a conical surface. Owing to such a convex shape of the head the material of the carton sleeve can slide particularly easily over the head. This allows a particularly smooth back folding and reduces the danger that the back folder will remain attached to the carton sleeves or that the surface of the generally expensively printed carton sleeve is scratched.

According to a further modification of the apparatus it is envisaged that each folding bar has at least one projection for the folding of the web areas. Owing to these projections a particularly effective pre-folding of the web areas can be achieved. Such a pre-folding is desired in particular in the region of the two “ends” of the web areas, since the material of the carton sleeve has to be folded by 180° in these regions. The pressing of the two ends of the web seam firmly together is also termed “pinching”. Preferably both folding bars have two projections for the folding of the web areas, wherein in each case one projection is associated with the first end of the web seam and the other projection is associated with the second end of the web seam.

The apparatus can in a further elaboration finally be complemented by a conveyor belt with cells for accommodating the carton sleeves. By means of a conveyor belt or a transporting belt high tractive forces can be transmitted, which enable a large number of carton sleeves to be transported at a constant distance from one another. The cells serve to accommodate the carton sleeves. The carton sleeves can be held by means of a positive engagement connection and also by a frictional connection in the cells. The conveyor belt is preferably arranged in a horizontal plane.

The object described in the introduction is also solved by a method for the pre-folding of carton sleeves. The method comprises the following steps: a) folding the ridge areas inwardly, b) folding the ends of the web area, and c) folding the triangular areas outwardly. The method is characterized in that the folding in step c) takes place in a contactless manner. A contactless folding is understood to mean a folding in which there is no contact between the folding tools and the areas to be folded (“passive folding”). A “passive” folding of the triangular areas can be achieved for example if the folding tools come into contact with the ridge areas and the ridge areas thus fold “actively”, whereby the triangular areas adjoining the ridge areas are moved “passively”. A “passive” folding is particularly gentle since the folded areas do not need to be clamped or wedged.

An elaboration of the method envisages an extension of the following steps: d) folding the ridge areas outwardly, and e) folding the triangular areas inwardly. The two extra steps relate to the back folding, the purpose of which is to fold back the pre-folded areas to a certain extent in the opposite direction. This serves on the one hand the aim of removing the folding block more easily from the carton sleeve, and on the other hand facilitates the filling of the carton sleeve with contents. The folding in step d) preferably takes place in a contactless manner. This can be achieved if the back folders are in contact with the triangular areas and the triangular areas thus “actively” fold inwardly, whereby the ridge areas adjoining the triangular areas are moved “passively” (outwardly).

According to a further elaboration of the method it is envisaged that the carton sleeves are moved by a conveyor belt with cells fastened thereto. As was already described hereinbefore in connection with the apparatus, high tractive forces can be transmitted by a conveyor belt or a transporting belt, which enable a large number of carton sleeves to be transported at a constant distance from one another. The cells serve to accommodate the carton sleeves. The carton sleeves can be held in the cells by a positive engagement connection as well as by a frictional connection. The conveyor belt is preferably arranged in a horizontal plane.

According to a further modification of the method it is finally proposed that the carton sleeves are moved intermittently, i.e. cyclically. An intermittent mode of operation has the advantage that the carton sleeves are stationary during the pre-folding and therefore can be folded particularly precisely. Also, the bearing and support of the folding tools can be designed more simply and robustly than in an installation in which the carton sleeves are transported further during the pre-folding.

The object described in the introduction is also solved by a system for pre-folding carton sleeves. The system comprises: an apparatus for the pre-folding of carton sleeves according to any one of Claims 1 to 11, and at least one carton sleeve.

The invention finally relates to a pre-folded carton sleeve, which is characterised in that the ridge areas of the carton sleeve are inclined inwardly in such a way that an angle of inclination in the range between 5° and 45° is formed between the ridge areas and the front area or the rear area, and that the ear-shaped sections of the carton sleeve are inclined outwardly in such a way that an angle of inclination in the range between 5° and 45° is formed between the ear-shaped sections and the side areas. Preferably the floor areas of the carton sleeve are sealed, i.e. closed.

The invention is described in more detail hereinafter with the aid of simply a preferred exemplary embodiment and with reference to the accompanying drawings, in which:

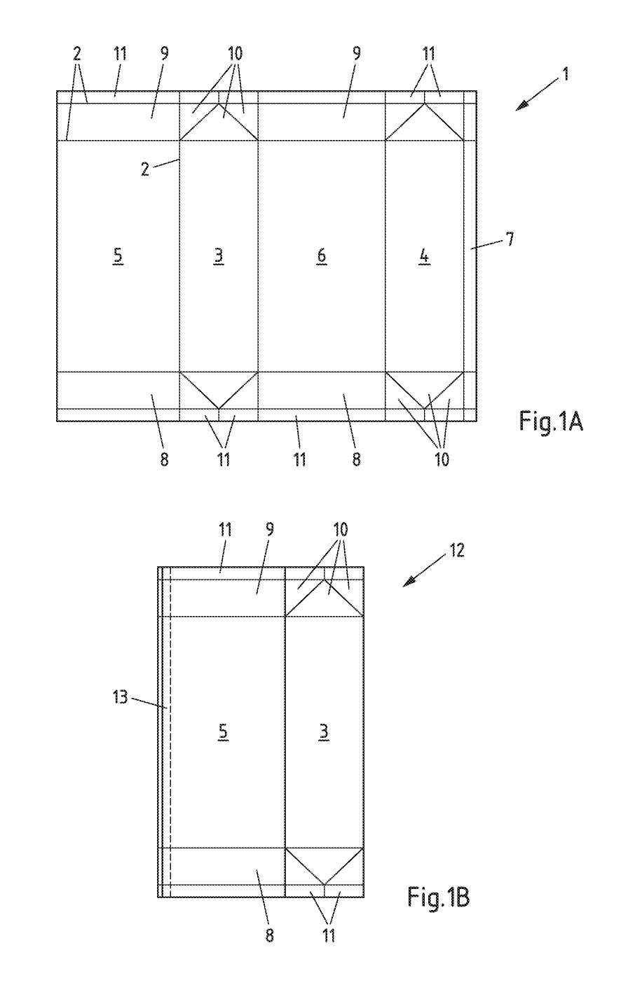

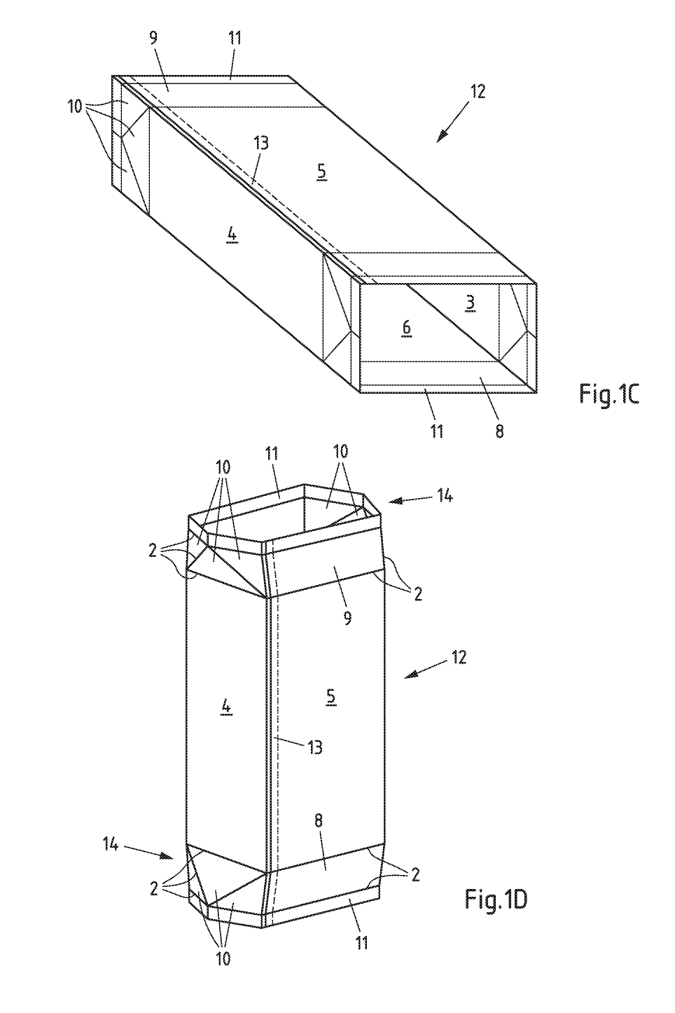

FIG. 1A: is a blank known from the prior art for folding a carton sleeve,

FIG. 1B: is a carton sleeve known from the prior art, which is formed from the blank illustrated in FIG. 1A, in the flat-folded state,

FIG. 1C: the carton sleeve from FIG. 1B in the folded-down state,

FIG. 1D: the carton sleeve from FIG. 1C with the pre-folded floor and ridge areas,

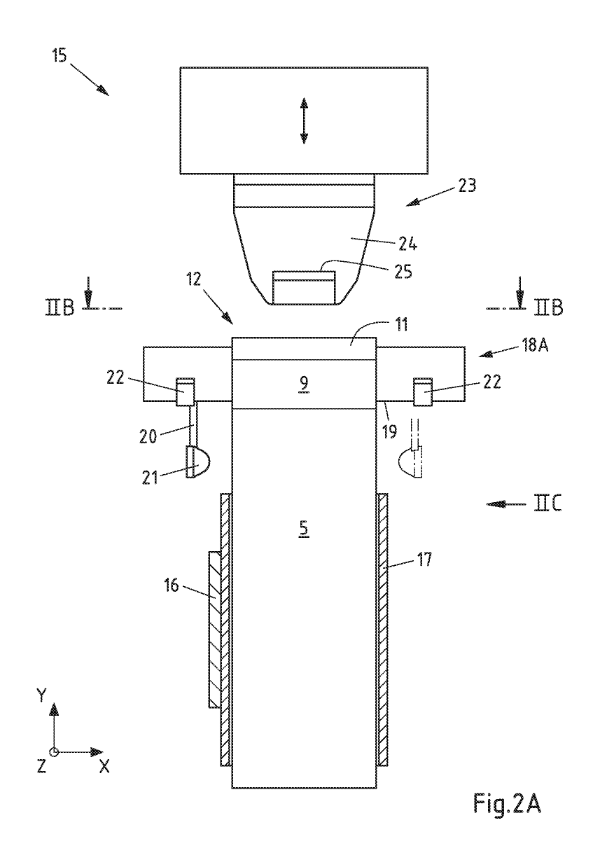

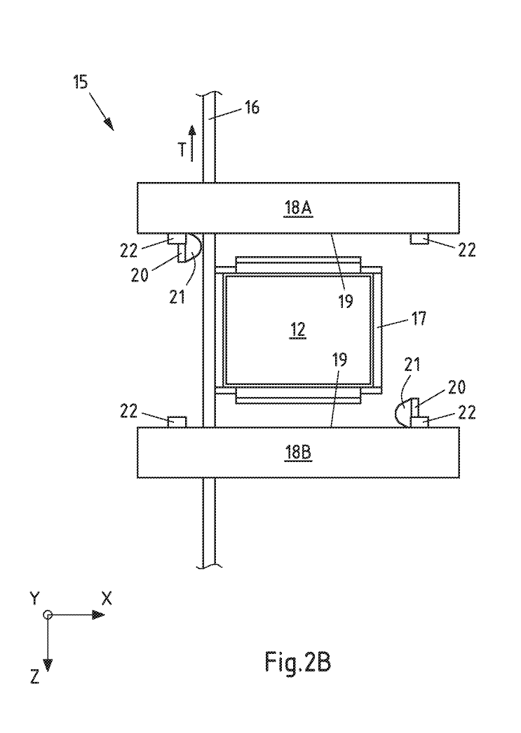

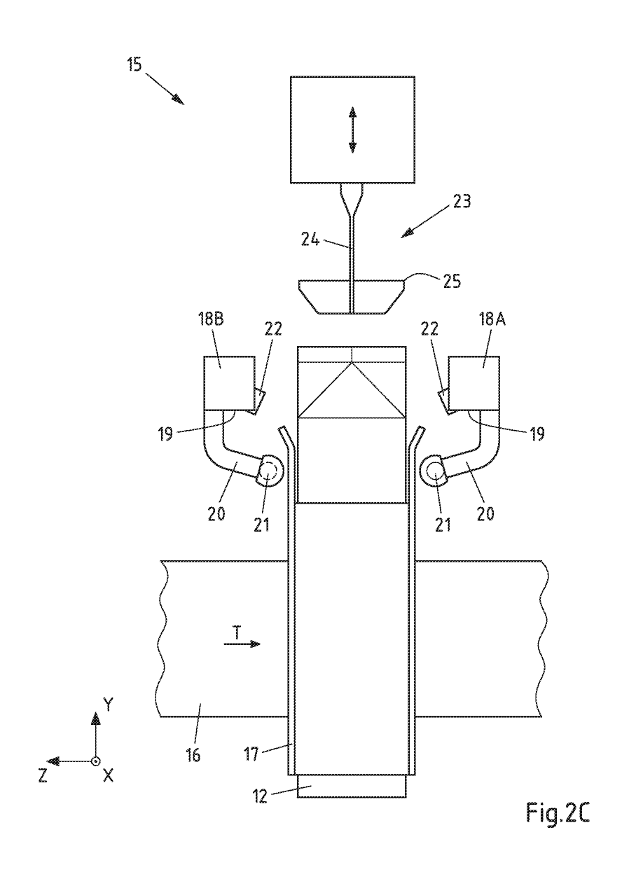

FIG. 2A: an apparatus according to the invention for the pre-folding of carton sleeves, in a front view,

FIG. 2B: the apparatus from FIG. 2A in plan view along the sectional plane IIB-IIB of FIG. 2A,

FIG. 2C: the apparatus from FIG. 2A in a side view along the sectional plane IIC-IIC of FIG. 2B,

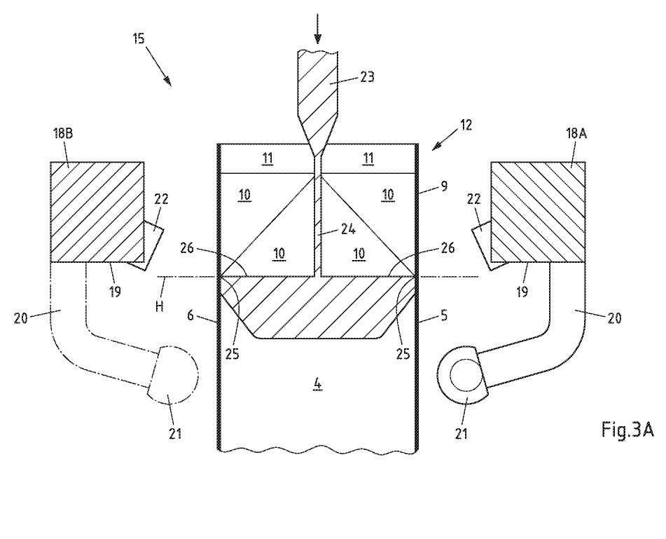

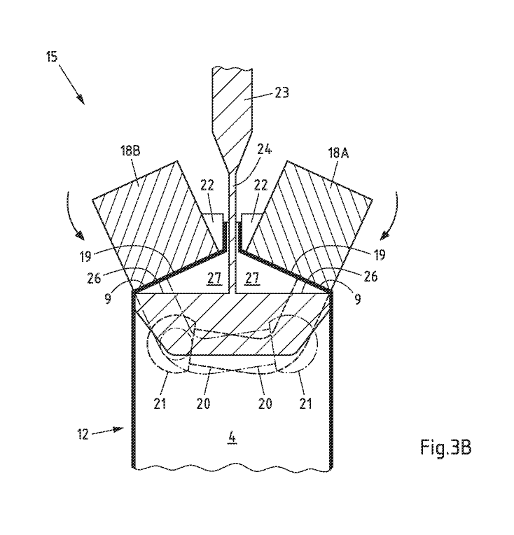

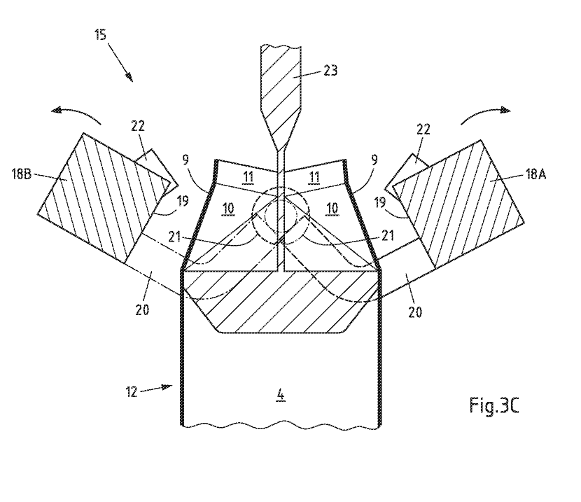

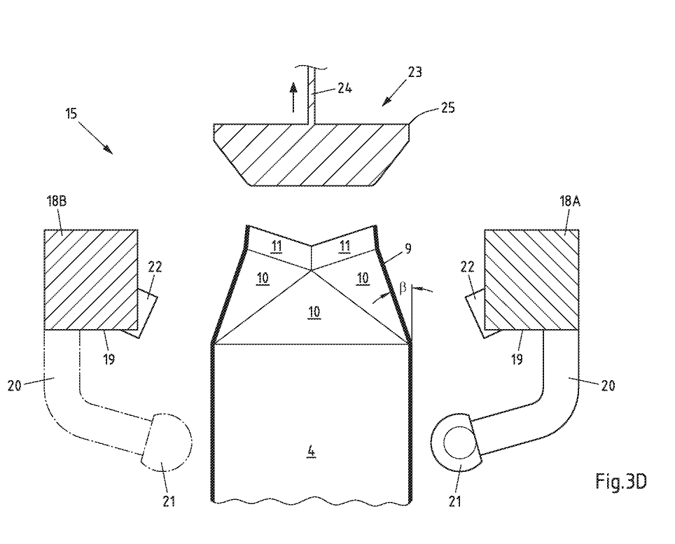

FIG. 3A: the apparatus of FIG. 2A in a first position in cross section,

FIG. 3B: the apparatus of FIG. 2A in a second position in cross section,

FIG. 3C: the apparatus of FIG. 2A in a third position in cross section,

FIG. 3D: the apparatus of FIG. 2A in a fourth position in cross section,

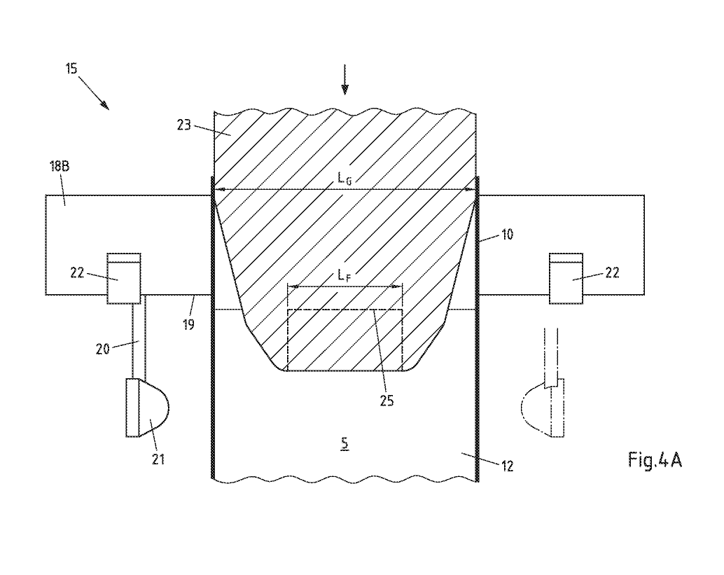

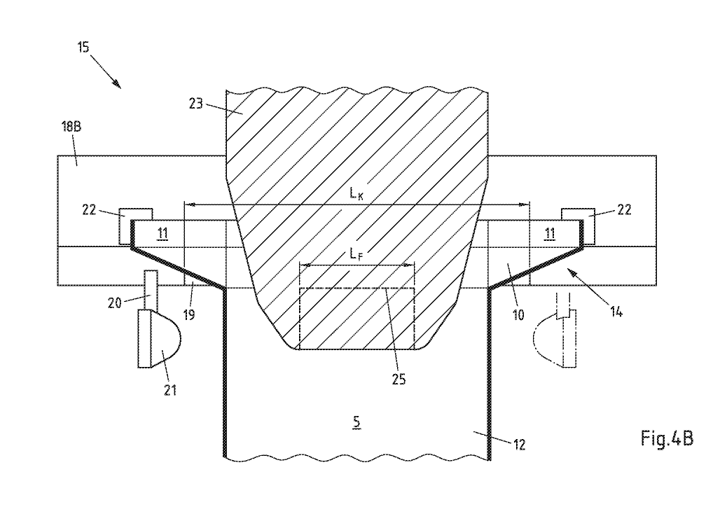

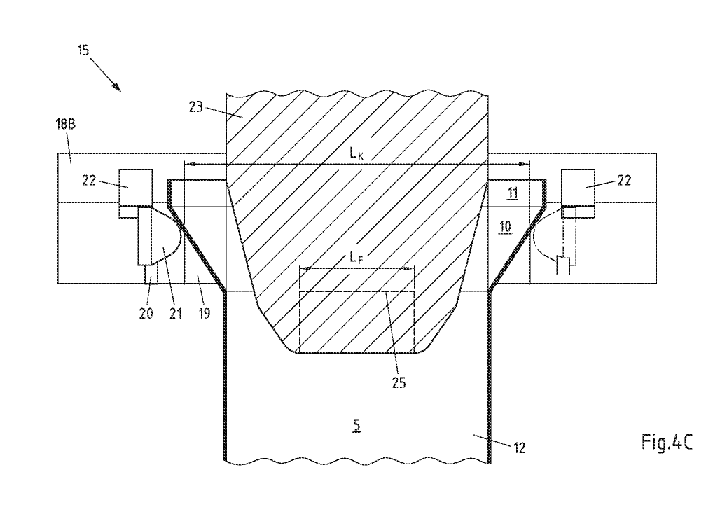

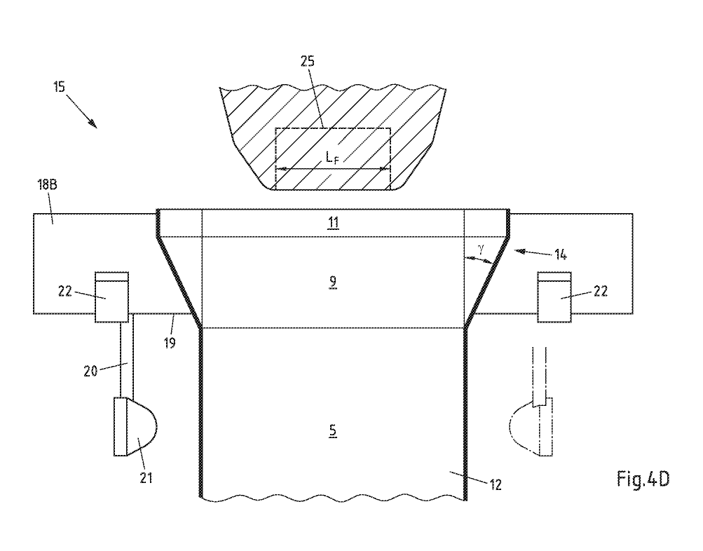

FIG. 4A: the apparatus of FIG. 2A in a first position in longitudinal section,

FIG. 4B: the apparatus of FIG. 2A in a second position in longitudinal section,

FIG. 4C: the apparatus of FIG. 2A in a third position in longitudinal section,

FIG. 4D: the apparatus of FIG. 2A in a fourth position in longitudinal section, and

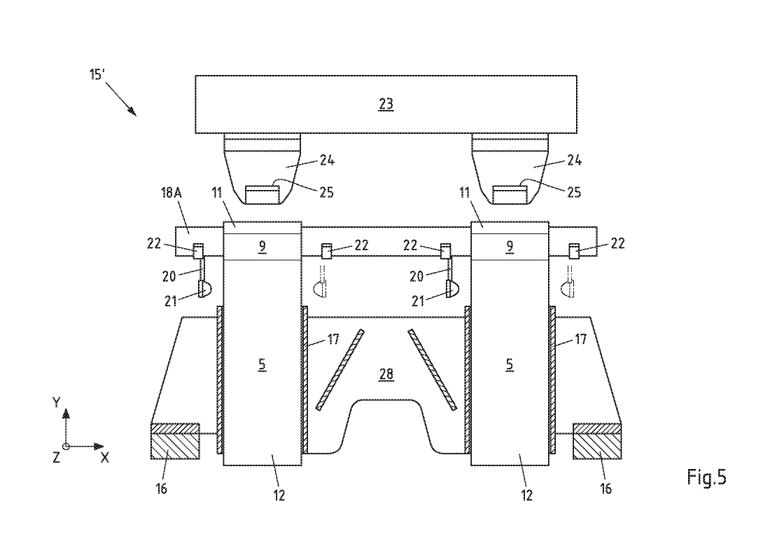

FIG. 5: an alternative embodiment of an apparatus according to the invention for the pre-folding of carton sleeves, in a front view.

FIG. 1A illustrates a blank 1 known from the prior art, from which a carton sleeve can be formed. The blank 1 can include several plies of different materials, for example paper, cardboard, plastic or metal, in particular aluminium. The blank 1 has several folding lines 2 (or “crease lines”), which are intended to facilitate the folding of the blank 1 and subdivide the blank 1 into several areas. The blank 1 can be subdivided into a first side area 3, a second side area 4, a front area 5, a rear area 6, a sealing area 7, two floor areas 8, two ridge areas 9 and twelve triangular areas 10. Web areas 11 adjoin the floor areas 8, the ridge areas 9 and the triangular areas 10. A carton sleeve can be formed from the blank 1 by folding the blank 1 in such a way that the sealing area 7 can be joined, in particular welded, to the front area 5.

FIG. 1B shows a carton sleeve 12 known from the prior art, in the flat folded state. The regions of the carton sleeve already described in connection with FIG. 1A are provided with corresponding reference numerals in FIG. 1B. The carton sleeve 12 is formed from the blank 1 shown in FIG. 1A. For this, the blank 1 was folded in such a way that the sealing area 7 and the front area 5 are arranged overlapping, so that the two areas can be welded flat over their area. As a result a longitudinal seam 13 is formed. In FIG. 1B the carton sleeve 12 is shown in a flat, folded-together state. In this state a side area 4 (covered in FIG. 1B) lies underneath the front area 5 while the other side area 3 lies on the rear area 6 (covered in FIG. 1B). In the flat folded-together state several carton sleeves 12 can be stacked in a particularly space-saving manner. Accordingly the carton sleeves 12 are often stacked at the place of manufacture and transported in the stacked state to the place where they are filled. Only there are the carton sleeves unstacked and folded out so that they can be filled with contents, for example with foodstuffs.

In FIG. 1C the carton sleeve 12 of FIG. 1B is in the unfolded state. Here too the regions of the carton sleeve 12 already described in connection with FIG. 1A or FIG. 1B are provided with corresponding reference numerals. By the unfolded state is understood a configuration in which an angle of about 90° is formed between the two respectively adjacent areas 3, 4, 5, 6, so that the carton sleeve 12 has—depending on the shape of the areas—a square or rectangular cross section. Corresponding to this the oppositely facing side areas 3, 4 are arranged parallel to one another. The same is true of the front area 5 and the rear area 6.

FIG. 1D shows the carton sleeve 12 of FIG. 1C in the pre-folded state, i.e. in a state in which the folding lines 2 had been pre-folded in the region of the floor areas 8 and also in the region of the ridge areas 9. The floor areas 8 and the ridge areas 9 are folded inwardly in the pre-folding and subsequently form the floor and the ridge of the packaging. The triangular areas 10 are on the other hand folded (generally passively) outwardly during the pre-folding and form projecting regions of excess material, which are also termed “ears” 14 and are attached to the packaging, for example by adhesive or bonding methods, in a subsequent production step. As an alternative to this the floor areas 8 of the carton sleeve 12 can already have been folded on a mandrel of a mandrel wheel and sealed, before the ridge areas 9 are pre-folded in the described way.

In FIG. 2A an apparatus 15 according to the invention for the pre-folding of carton sleeves is illustrated in a front view. A conveyor belt 16 with cells 17 is also illustrated, in which the carton sleeves 12 are first of all fed to the apparatus 15 and are there pre-folded in the ridge region. The transporting direction T of the carton sleeves 12 therefore runs parallel to the conveyor belt 16. The apparatus 15 comprises two folding bars 18A, 18B for the pre-folding of the ridge areas 9 of the carton sleeves 12. For the sake of clarity only the rear folding bar 18A is illustrated in FIG. 2A. The folding bars 18A, 18B are arranged on opposite sides of the carton sleeves 12 and are mounted in a vertically displaceable and rotatable manner. Each folding bar 18A, 18B has a flat contact area 19 for folding the ridge areas 9. In addition each folding bar 18A, 18B has a back folder 20 for folding back the ears 14 of the carton sleeves 12. The back folder 20 illustrated in FIG. 2A and to this extent preferred has a head 21, which comprises a conical jacket-shaped section and a spherical section. Each folding bar 18A, 18B has in addition at least one projection 22 for folding the web areas 11.

The apparatus illustrated in FIG. 2A comprises in addition to the two folding bars 18A, 18B also a folding block 23, which is arranged centrally above the carton sleeves 12 and is mounted in a linearly displaceable manner. The folding block 23 can in particular be mounted in a displaceable manner in the vertical direction Y. The folding block 23 has a web 24, which in its lower region has a folding edge 25 on both sides. The folding edges 25 serve to “break” the folding lines between the ridge areas 9 and the front area 5 and the rear area 6.

FIG. 2B shows the apparatus 15 of FIG. 2A in a plan view along the sectional plane IIB-IIB of FIG. 2A. The regions of the apparatus 15 already described in connection with FIG. 2A are provided with corresponding reference numerals in FIG. 2B. In the plan view the arrangement of the two folding bars 18A, 18B can be recognised particularly clearly. Each folding bar has a flat contact area 19 and a back folder 20, wherein the back folder 20 of the rear folding bar 18A is arranged diagonally opposite the back folder 20 of the front folding bar 18B. In this way one back folder 20 can fold back the left ear 14, while the other back folder 20 can fold back the right ear 14. In addition both folding bars 18A, 18B have respectively two projections 22 for folding the web areas 11. In the plan view it can be seen that in each case two projections 22 are associated with one another and are arranged opposite one another, so that in each case two projections 22 co-operate and can fold the web area 11 together at both “ends”.

In FIG. 2C the apparatus of FIG. 2A is illustrated in a side view along the sectional plane IIC-IIC of FIG. 2B. Here too the regions of the apparatus 15 already described in connection with FIG. 2A or FIG. 2B are provided with corresponding reference numerals. In the side view it can be seen particularly clearly that the folding bars 18A, 18B and the folding block 23 adopt in FIG. 2C a neutral, open position, in which a free space is formed between the two oppositely arranged folding bars 18A, 18B and the folding block 23, and in which the unfolded carton sleeves 12 can be arranged. During the folding procedure the folding bars 18A, 18B and the folding block 23 adopt a different position however, which will be discussed in more detail hereinafter.

FIG. 3A shows the apparatus 15 of FIG. 2A in a first position in cross section. Also, in FIG. 3A the regions of the apparatus already described in connection with FIG. 2A to FIG. 2C are provided with corresponding reference numerals. In the first position the two folding bars 18A, 18B adopt a neutral position, in which neither the folding bars 18A, 18B themselves, nor the back folders 20 fastened thereto, come into contact with the carton sleeve 12. The folding block 23 on the other hand was already inserted from above into the carton sleeve 12, so that it adopts a sunken position in FIG. 3A. The folding block 23 was lowered until the folding edges 25 of the folding block 23 are located at the height of those folding lines 2 that separate the front area 5 and the rear area 6 from the ridge areas 9. The folding block 23 comprises two support surfaces 26, which are arranged on opposite sides of the web 24. The supporting surfaces 26 preferably have an angle of inclination a of 5° or less, in particular 0°, with respect to a horizontal plane H.

In FIG. 3B the apparatus 15 of FIG. 2A is illustrated in a second position in cross section. Also in FIG. 3B the regions of the apparatus 15 already described in connection with FIG. 2A to FIG. 3A are provided with corresponding reference numerals. In the second position the folding block 23 is unaltered in a lowered position. The two folding bars 18A, 18B were on the other hand swung inwardly (schematically illustrated by arrows), so that the contact areas 19 of the folding bars 18A, 18B touch and force inwardly the ridge areas 9 of the carton sleeve 12. In this connection the (not illustrated in FIG. 3B) triangular areas move passively—i.e. without being contacted by the folding bars 18A, 18B—outwardly, whereby the ears 14 are formed. The folding block 23 preferably has a web 24 with a web width of less than 3 mm, in particular less than 2 mm, so that the ridge areas 9 can be folded particularly far inwardly. Since the angle of inclination a in the case of the folding block 23 illustrated in FIG. 3B and to this extent preferred is 0°, a free space 27 is formed between the supporting surfaces 26 and the ridge areas 9. It was therefore intentionally decided to avoid using the supporting surfaces 26 in the folding procedure as a support for the ridge areas 9, in order to avoid damage to the carton sleeve 12.

FIG. 3C shows the apparatus 15 of FIG. 2 in a third position in cross section. Also in FIG. 3C the regions of the apparatus 15 already described in connection with FIG. 2A to FIG. 3B are provided with corresponding reference numerals. Also in the third position the folding block 23 is unchanged in a lowered position. The two folding bars 18A, 18B had however been swiveled outwardly, whereby the back folders 20 fastened to them move inwardly (schematically illustrated by arrows). As a result the heads 21 of the back folders 20 contact the ears 14 of the carton sleeves 12 and again force them upwardly to some extent. In this connection the ridge areas 9 move passively—i.e. without being contacted by the back folders 20 or folding bars 18A, 18B—again outwardly to some extent.

In FIG. 3D the apparatus 15 of FIG. 2A is illustrated in the fourth position in cross section. Also in FIG. 3D the regions of the apparatus 15 already described in connection with FIG. 2A to FIG. 3C are provided with corresponding reference numerals. In the fourth position the two folding bars 18A, 18B were first of all swiveled again into the neutral position, which was already described in connection with FIG. 3A. Then the folding block 23 was again displaced upwardly from the carton sleeve 12, so that it adopts a raised position in FIG. 3D. The distance between the two ridge areas 9 is of course less than the distance between the two folding edges 25 of the folding block 23. Nevertheless, the folding block 23 can on account of the elasticity of the carton sleeve 12 be removed from the carton sleeve 23, since in this connection the two ridge areas 9 are first of all forced again into the vertical position and then spring back to the inwardly inclined position. As a result of the folding back the ridge areas 9 are inclined inwardly in such a way that an angle of inclination 3 in the range between 5° and 45° is formed between the ridge areas 9 and the front area 5 or the rear area 6.

FIG. 4A shows the apparatus 15 of FIG. 2A in a first position in longitudinal section. Also in FIG. 4A the regions of the apparatus 15 already described in connection with FIG. 2A to FIG. 3D are provided with corresponding reference numerals. The position illustrated in FIG. 4A corresponds to the position known from FIG. 3A, in which the view has been rotated by 90°. In the longitudinal section it can clearly be seen that the width of the folding block 23 is just as wide or wider than the width of the front area 5 (and of the not illustrated rear area 6). This has the aim of ensuring that the triangular areas 10 in the folding procedure can only move outwardly, but not inwardly. Likewise, in the longitudinal section it can clearly be seen that the length L_{F} of the folding edge 25 is shorter than the length L_{G} of the ridge area 9, preferably is at least 5% shorter or at least 10% shorter. It is therefore intentionally decided not to continue the folding edge 25 into the corners of the carton sleeve 12, in order to avoid damage in this region of the carton sleeve 12.

In FIG. 4B the apparatus 15 of FIG. 2A is illustrated in a second position in a longitudinal section. Also in FIG. 4B the regions of the apparatus 15 already described in connection with FIG. 2A to FIG. 4A are provided with corresponding reference numerals. The position illustrated in FIG. 4B corresponds to the position known from FIG. 3B, in which the view is rotated by 90°. In the longitudinal section it can clearly be seen that an inwards folding of the ridge areas 9 results in an outwards folding of the triangular areas 10, whereby projecting ears 14 are formed on the two narrow sides of the carton sleeve 12. In addition the position and function of the projections 22 is clearly recognisable: they should press together and thereby pre-fold the two “ends” of the web area 11. The contact area 19 of the folding bar 18B is formed flat and has a length L_{K} that is longer than the length L_{G} of the ridge areas 9 folded by it. In this way it is ensured that the ears 14 do not come into contact with the contact area 19 during the folding procedure, and a particularly careful folding is thus achieved.

FIG. 4C shows the apparatus 15 of FIG. 2A in a third position in a longitudinal section. Also in FIG. 4C the regions of the apparatus 15 already described in connection with FIG. 2A to FIG. 4B are provided with corresponding reference numerals. The position illustrated in FIG. 4C corresponds to the position known from FIG. 3C, in which the view is rotated by 90°. Clearly recognizable is the contact between the head 21 of the back folder 20 and the ears 14 of the carton sleeves 12, which are again forced upwardly to some extent by the back folders 21. In this connection the ridge areas 9 move passively—i.e. without contact by the back folders 20 or folding bars 18A, 18B—again outwardly to some extent.

In FIG. 4D the apparatus of FIG. 2A is illustrated in a fourth position in a longitudinal section. Also in FIG. 4D the regions of the apparatus 15 already described in connection with FIG. 2A to FIG. 4C are provided with corresponding reference numerals. The position shown in FIG. 4D corresponds to the position known from FIG. 3D, in which the view is rotated by 90°. The folding block 23 again adopts in FIG. 4D the raised position, after which it was removed from the carton sleeve 12. The ridge areas 9 are folded slightly inwardly while the triangular areas 10 are folded slightly outwardly and form projecting ears 14. As a result of the back folding the ears 14 are inclined outwardly in such a way that between the ears 14 and the side areas 3, 4 an angle of inclination γ in the range between 50 and 45° is formed.

FIG. 5 shows finally an alternative embodiment of an apparatus 15′ according to the invention for the pre-folding of carton sleeves, in a front view. As an alternative to the elaboration of the apparatus 15 illustrated in FIG. 2A to FIG. 4D, in the apparatus 15′ shown in FIG. 5 it is envisaged that the apparatus simultaneously folds two carton sleeves 12. This is achieved by an extension of the folding bars 18A, 18B as well as by a corresponding increase in the number of folding blocks 23 and structural parts (back folders 20, projections 22) provided on the folding bars 18A, 18B. The cells 17 are joined to one another via a rigid bridge 28. The bridge 28 is driven by two conveyor belts 16. By means of an appropriate adaptation types of apparatus are also possible in which three or more carton sleeves can be simultaneously folded.

### LIST OF REFERENCE NUMERALS

1: Blank
2: Folding line
3, 4: Side areas
5: Front area
6: Rear area
7: Sealing area
8: Floor area
9: Ridge area
10: Triangular area
11: Web area
12: Carton sleeve
13: Longitudinal seam
14: Ear
15: Apparatus for pre-folding
16: Conveyor belt
17: Cell
18A. 18B: Folding bar
19: Contact area
20: Back folder
21: Head (of the back folder 20)
22: Projection
23: Folding block
24: Web (of the folding block 23)
25: Folding edge (of the folding block 23)
26: Supporting surface (of the folding block 23)
27: Free space
28: Bridge
α: Angle of inclination (of the supporting surfaces 26)
β: Angle of inclination (of the ridge areas 9)
γ: Angle of inclination (of the ears 14)
H: Horizontal plane
L_{F}: Length (of the folding edge 25)
L_{G}: Length (of the ridge area 9)
L_{K}: Length (of the contact area 19)
T: Transporting direction (of the carton sleeves 12)
X: Longitudinal direction
Y: Height direction
Z: Transverse direction

1.-17. (canceled)

18. An apparatus for the pre-folding of carton sleeves, comprising:
at least two folding bars for pre-folding of ridge areas and triangular areas of the carton sleeves,
at least one folding block insertable into the carton sleeves, and
at least one back folder for folding back the triangular areas,
wherein the folding bars each have a contact area for the pre-folding of the ridge areas, and
wherein the folding bars are arranged on opposite sides of the folding block and are rotatably mounted,
wherein the back folder is connected to one of the folding bars.

19. The apparatus according to claim 18, wherein the folding block is mounted in a linearly displaceable manner.

20. The apparatus according to claim 18, wherein the folding block has a web with a web width of less than 3 mm.

21. The apparatus according to claim 18, wherein the folding block has two oppositely arranged folding edges for folding the ridge areas.

22. The apparatus according to claim 21, wherein the length of the folding edges is at least 5% less than the length of the ridge areas to be folded.

23. The apparatus according to claim 18, wherein the folding block has two oppositely arranged supporting surfaces, which are disposed between the folding edges and the web, and which have an angle of inclination of 5° or less with respect to a horizontal plane.

24. The apparatus according to claim 18, wherein the contact areas of the folding bars are formed planar.

25. The apparatus according to claim 18, wherein the back folder has a conical-shaped or spherical-shaped head.

26. The apparatus according to claim 18, wherein each folding bar has at least one projection for folding the web areas.

27. The apparatus according to claim 18, further comprising:
a conveyer belt with cells for receiving the carton sleeves.

28. A method for pre-folding of carton sleeves, comprising the following steps:
a) folding the ridge areas inwardly,
b) folding the ends of the web area, and
c) folding the triangular areas outwardly,
wherein the folding in step c) is carried out in a contactless manner,
wherein the folding in step b) is carried out actively by at least one projection of a folding bar.

29. The method according to claim 28, further comprising the following steps:
d) folding the ridge areas outwardly, and
e) folding the triangular areas inwardly.

30. The method according to claim 28, wherein the carton sleeves are moved by a conveyor belt with cells fastened thereto.

31. The method according to claim 28, wherein the carton sleeves are moved intermittently.

32. A system for pre-folding of carton sleeves, comprising:
an apparatus for pre-folding carton sleeves according to claim 18, and
at least one carton sleeve.

33. The apparatus according to claim 20, wherein the web width is less than 2 mm.
